(19) United States
(12) Patent Application Publication
(10) Pub. No.: US 2025/0047939 A1
(43) Pub. Date: Feb. 6, 2025

(54) Machine-Learning Assisted Personalized Real-Time Video Editing and Playback

(71) Applicants: Jason Henderson, Littleton, CO (US); Julia Guzman-Henderson, Littleton, CO (US)

(72) Inventors: Jason Henderson, Littleton, CO (US); Julia Guzman-Henderson, Littleton, CO (US)

(21) Appl. No.: 18/922,399

(22) Filed: Oct. 22, 2024

(51) Int. Cl. H04N 21/45; H04N 21/4545; H04N 21/475

(52) U.S. Cl. CPC H04N 21/4532; H04N 21/45457; H04N 21/4755

(57) ABSTRACT

The invention provides a system for machine-learning assisted real-time video editing and playback. Users select content, and the system uses machine learning to analyze preferences and edit the content in real time. The system is distinguished by its ability to process real-time user commands (via text or voice) during playback, adjusting the video dynamically. Personalized versions of movies, shows, or other video content are then generated and played back to the user, based on preferences provided or inferred through the system.

### CROSS-REFERENCE TO RELATED APPLICATIONS

N/A

### FIELD OF THE INVENTION

The present invention relates to the field of multimedia content editing and playback. More specifically, it pertains to a system and method for using machine learning and artificial intelligence (AI) to provide personalized real-time video editing and playback based on user preferences.

### Appropriate Classifications

G06T 11/60—Machine learning in image or video processing.
H04N 21/2343—Personalized content delivery in video processing.
G06F 17/30—Information retrieval using machine learning techniques.
H04N 21/2662—Editing of audio-visual content based on user preferences.
G06Q 30/06—Systems involving user modeling for personalized content delivery.

### BACKGROUND OF THE INVENTION

In the age of on-demand video services, users have access to vast amounts of multimedia content across various genres, including movies, television shows, and other forms of recorded video content. However, the availability of content often presents challenges to users, particularly when they prefer certain aspects of a show or movie, such as specific characters, storylines, or themes. Currently, users must manually search through video content to find the segments that interest them, which can be time-consuming and inefficient.

There is a growing need for a system that can tailor video content to match the preferences of individual users. The use of artificial intelligence (AI) and machine learning (ML) technologies has opened new possibilities for automating and optimizing content personalization. While existing systems may automate some aspects of video editing based on pre-determined criteria or metadata (e.g., highlighting key moments or scenes based on generalized user preferences), they do not allow users to make real-time, dynamic requests during playback to alter the content. This invention addresses that gap by providing a system that not only personalizes video content but does so in real time, based on direct user commands (e.g., text or voice) to modify the content they are currently watching.

### SUMMARY OF THE INVENTION

The present invention provides a system and method for machine-learning assisted personalized real-time video editing and playback. This service allows users to select on-demand or recorded content, such as movies, television shows, or other video material. Using machine learning and AI technologies, the system analyzes user preferences based on explicit inputs, search terms, or historical viewing data, and edits the selected content in real time to produce a personalized version that matches the user's preferences.

For example, a user watching a soap opera with multiple storylines can provide the system with instructions to show only the storylines featuring preferred characters. The system then edits out scenes unrelated to those characters and generates a customized version of the episode for immediate playback. Unlike existing systems, which automatically process content based on pre-configured settings, this invention allows users to interact with the system in real time, providing voice or text commands to alter the playback experience while the content is being viewed.

The invention includes the following components:
A machine learning module that processes user preferences and content metadata.
A content filtering and editing engine that modifies video content in real-time.
A playback system that delivers the personalized video to the user's device.
An interface that allows the user to input real-time preferences or interact with the system using text or voice commands, unlike prior inventions that rely solely on pre-set preferences.

### BRIEF DESCRIPTION OF THE DRAWINGS

A further understanding of the nature and advantages of various embodiments may be realized by reference to the attached figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. It should be understood that television receiver 200, along with the other computerized systems and devices detailed herein, may include various computerized components including memories, processors, data buses, user interfaces, power supplies, etc. Such components have been omitted from the description and figures for simplicity.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the attached elements may be components of a larger system, wherein other rules may take precedence over or otherwise modify the application of the invention. Also, a number of steps may be undertaken before, during, or after the pictured elements are considered.

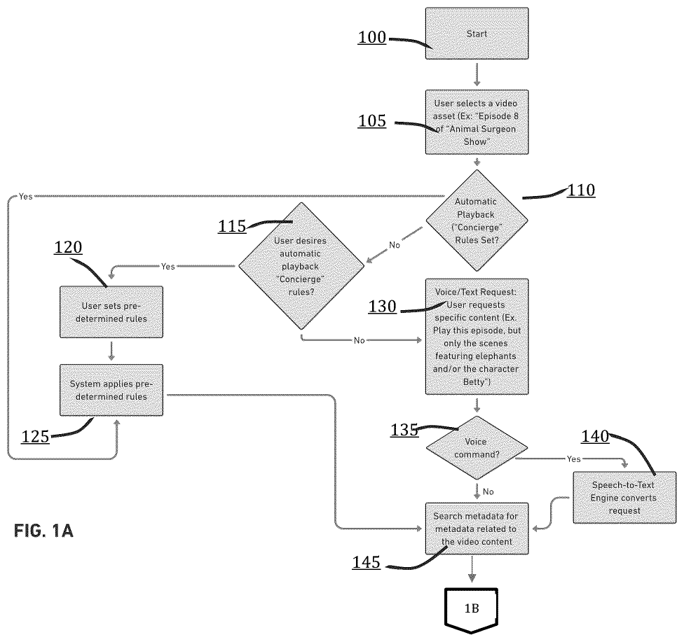

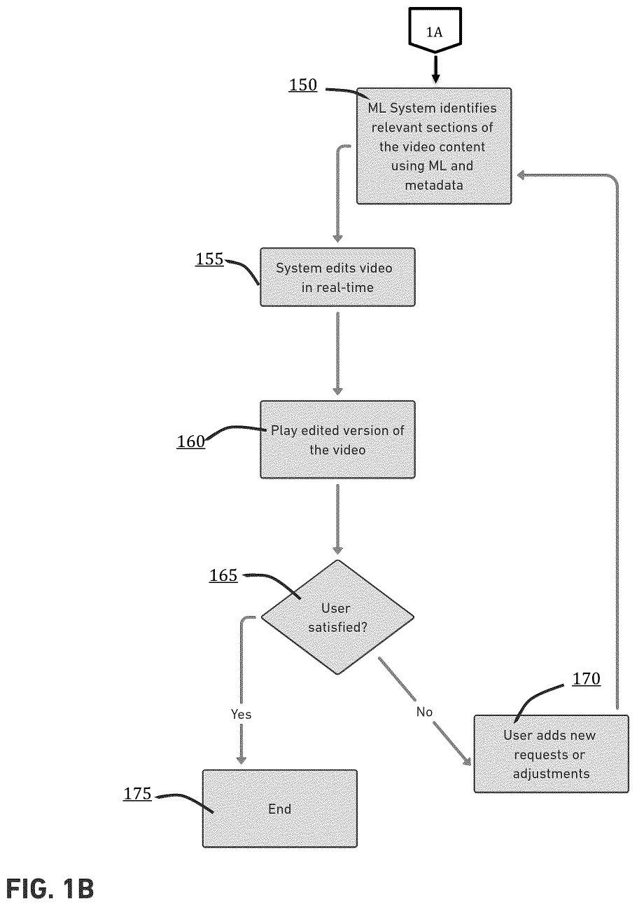

### FIG. 1A-1B. Utility Flow Description

FIGS. 1A to 1B describe the utility flow of the proposed system, incorporating for better understanding a mixture of the user's actions and the system's responses as enabled by the invention.

The user may begin at a screen where they can choose what content to watch (100). This screen includes various options such as shows, episodes, or movies, depending on the platform or system in use.

Next, the system initializes, checking for any prior interactions or user preferences that need to be loaded to guide the process (105). This ensures the system is prepared to personalize the content or respond to user inputs.

The system then checks whether any pre-determined rules (or “Concierge” rules or personalization settings), are in place (110). These rules, if found, will influence how the system presents or modifies content for the user.

If no pre-determined rules are identified, the system moves on to offer default settings or request input from the user about how to handle the content (115). This gives the user a choice between proceeding with the default experience or customizing it further.

If the user chooses to set personalization rules (115), they may set new rules (120). An example would be, “from now on always play this program only showing scenes featuring the character “Betty.”

Having received the new rules, the system can apply the rules (125) and proceed to searching applicable third-party and other available metadata (145) to apply rules to editing.

If the user did have pre-determined rules set, the system applies those rules (125) and proceeds to searching for applicable third-party and other available metadata (145) to apply rules to editing.

If the user did not have pre-determined rules set and did not want to create any, they would enter a real-time request (130). The user submits a request for changes, which could involve filtering content by themes, specific characters, or other elements identified in the metadata. This request can be made using voice or text, such as, “Play this episode, but only show scenes with the character “Betty.”

If the command was delivered by voice (135) then the system converts the voice command to text or such form as the system can understand and use to search metadata.

The system takes the request (for example, ‘Play only those scenes with the character “Betty”’ or more complicated requests like “Play only those scenes with the character ‘Betty’ or with elephants, but play no scenes with the character ‘Adam’” and searches metadata sources for metadata to identify the characters and other elements in the scenes (145). This metadata may come from a variety of sources including user generation, third-party providers, and artificial intelligence.

The system identifies the relevant sections (150) of the video content using machine learning and the metadata and applies (155) the requested changes, modifying the content according to the user's input. This may involve removing certain scenes or reordering the content to highlight specific elements.

The modified content is then prepared for playback, and any final checks or adjustments are completed to ensure a smooth viewing experience (160). The content is queued and ready for delivery. The personalized content is presented to the user for viewing. At this stage, the system either prompts the user to begin playback or automatically starts the customized content. (This choice of automatic start may be pre-determined by the user.)

As the user watches, the system monitors their engagement (165) and may offer options for additional feedback or real-time adjustments (170). The system tracks user preferences and makes note of any further input.

Finally, the process concludes, either ending the session or allowing for additional interactions based on the user's preferences (175). The system either terminates the process or loops back to accommodate further requests.

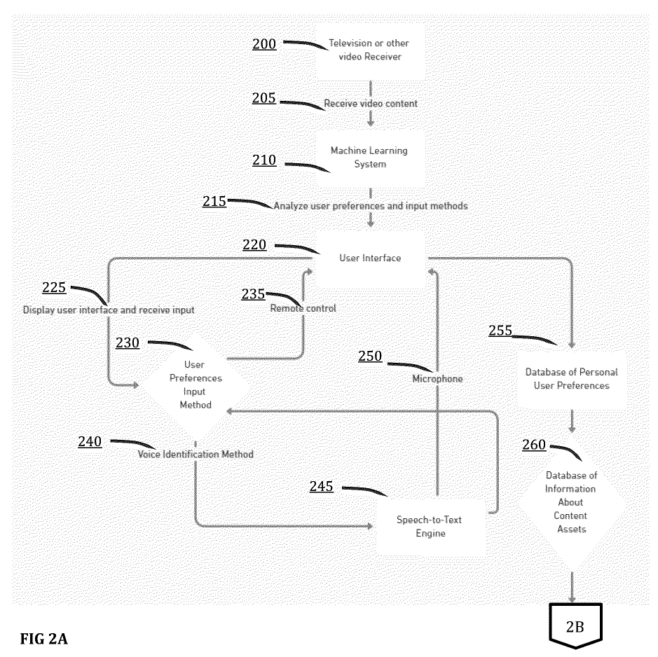

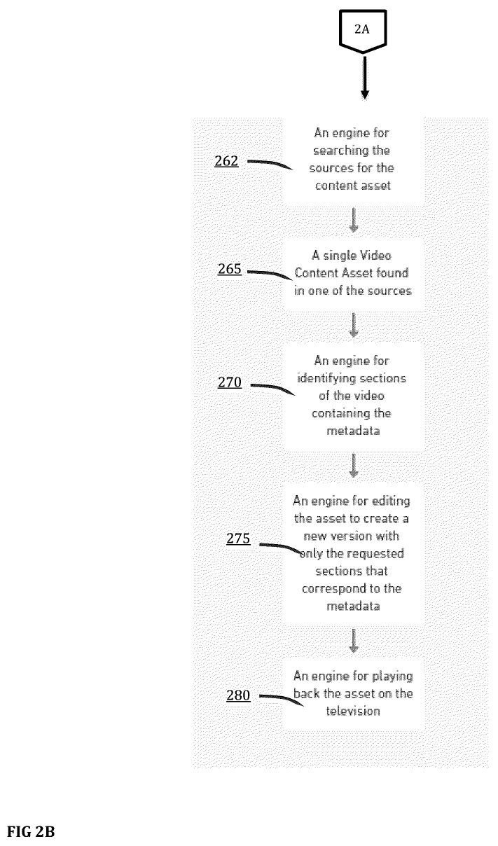

### FIG. 2A-2B. System Diagram Description

FIGS. 2A to 2B describe in brief the main components of the system. (The components are understood to be composites of the possible individual internal components that make each one possible; for example, the engine for playing back an asset (280) assumes the presence of “codecs” or other technologies to allow the playback of video on a piece of technology.)

The user watches content on their primary device, which could be a television, computer, or other video receiver (200). This is the device where the personalized content will be delivered for viewing.

The system receives video content from a source such as a streaming service or digital content provider (205). The content includes metadata tags that describe the scenes, characters, and other elements of the video.

A machine learning/artificial intelligence system (210) is present that can analyzes the user's preferences, either based on new input or historical data or specific input provided during a session. An example of an input would be the request, “Play only those scenes involving the character “Betty” or involving elephants” or a saved preference of the same request.

The machine learning system performs an in-depth analysis of the content's metadata to identify which scenes, characters, or themes match the user's preferences (215). This could include recognizing patterns such as favorite actors, specific genres, or desired content elements.

The user interacts with the system by way of a user interface (220) which can display choices on the user interface and receive input (225) by a variety of input methods (230), either remote control (235) or voice (240). Voice is converted via a speech-to-text engine (245) back into text and transported back to the user interface via the remote (225) or a microphone (250) (a microphone is understood to be an example; there may be a variety of other such devices for capturing inputs which must be converted to be understood by the system.)

The system keeps and adds new requests to a database of personal preferences (255) to further enhance each and future sessions.

The system keeps and has access to a database of metadata information (260) about the content assets—this metadata may be sourced from user additions, other-user-generated additions, third-party metadata, and machine-learning-generated metadata.

The system maintains an engine for searching the metadata sources (262) for a single content asset (262), such as the requested episode (262).

The system maintains an engine for identifying sections of the video asset (275) that contain the requested metadata, such as scenes within an episode that contain the character “Betty” or the thing “elephants.”

The system provides an engine (275) for real-time editing of the asset to create the new version of the asset.

The system provides an engine for playing back (280) the requested asset on the television (or other device) once editing according to the request is completed.

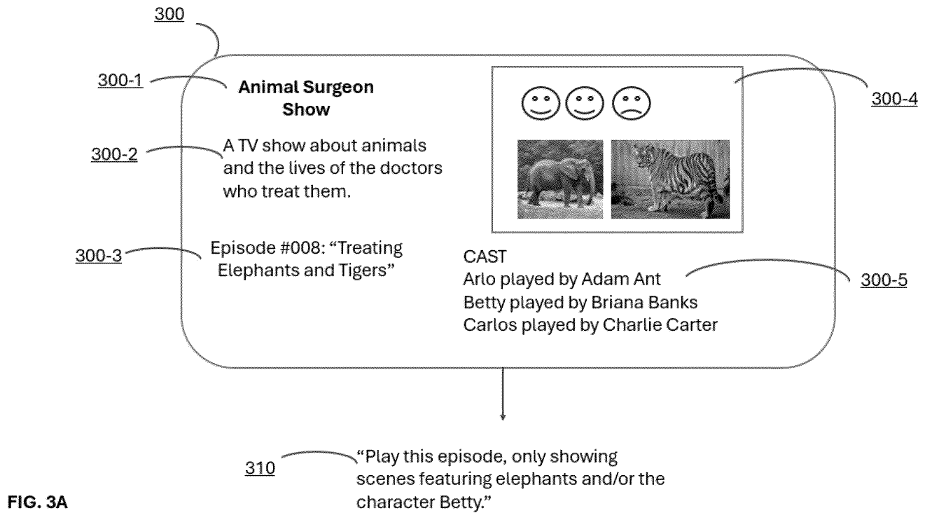

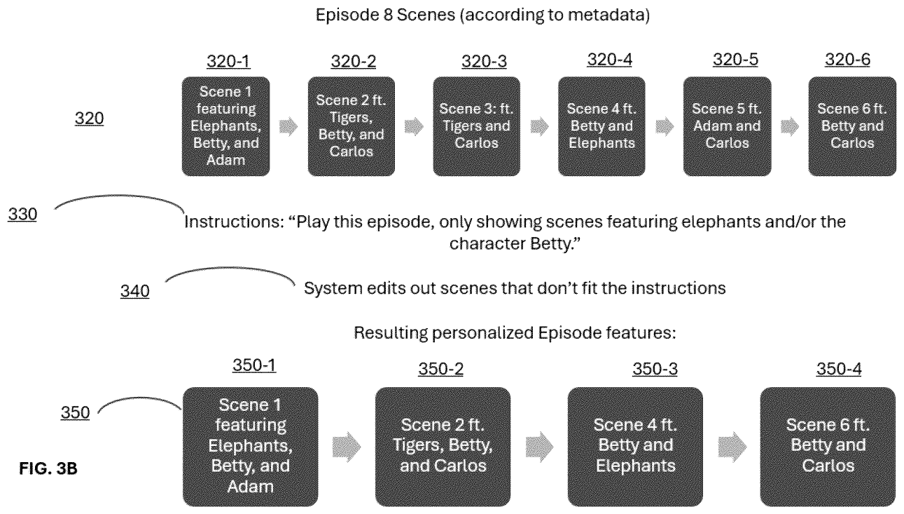

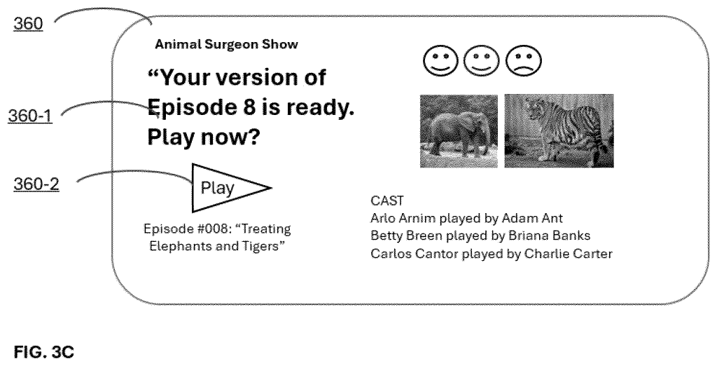

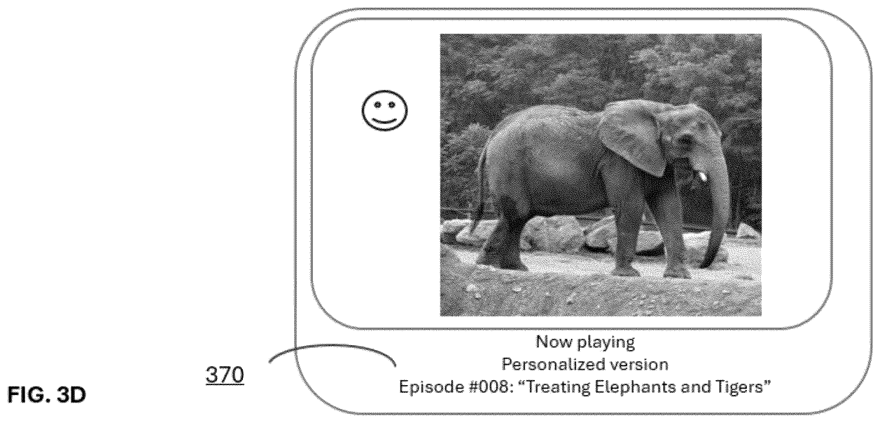

### FIG. 3 User Flow Description

FIGS. 3A to 3D describe in brief the user-facing or user-perceived flow of the system, without reference to those components that would be invisible to the user. For example, 340 “System edits out scenes . . . ” does not show the user what sources are being consulted; rather the user is notified that the work is merely being done in real time.

The user starts by looking at a TV screen that provides information about the selected TV show (300). The screen displays information about the title with metadata such as the title of the show (300-1), a brief description of the show (300-2), the episode title (300-3), an image, logo or poster from the show (300-4) and cast information including key actors and their roles (300-5). (Note that different television and video providers may provide more metadata or less, but this is example is a typical scenario in the video asset provision industry.) At this point, the user may provide a voice or text request (310) for a personalized version of the episode, such as asking to only see scenes with certain characters or elements. (Play this episode, only showing scenes featuring elephants and/or the character ‘Betty.’”)

The system ascertains (based on its search of metadata) that there are a set of scenes (320) including, for example Scenes 1 to Scene 6 (320-1 to 320-6).

The system processes the user's request (330) by analyzing the metadata associated with the episode. It identifies relevant scenes based on the request, such as only showing scenes with specific characters or themes.

Based on the metadata, the system filters the episode to match the user's request. It selects the scenes that meet the criteria, such as those featuring certain characters, and excludes scenes that do not match the request.

The system then complies a new set of scenes (350) by removing non-relevant scenes and assembling the personalized version of the episode (for example, containing only Scenes 1, 2, 4, and 6, if those are the only scenes matching the request) This set of scenes only includes the scenes that the user has requested to see.

Once the personalized version is ready, the system notifies the user that their customized episode (360) is available for playback. A message may be displayed prompting the user to start watching (360-1) with a user interface function (360-2) such as, for example, a “Play” button.

When the user clicks “Play,” the system begins playback of the customized episode (360). The screen may display the title of the episode with a note indicating that it has been personalized. The personalized episode only includes the scenes matching the user's request. The customized content is played as per the user's preferences.

### DETAILED DESCRIPTION OF THE INVENTION

### System Overview

The invention consists of a series of interconnected components that work together to provide personalized video content to users. At its core, the system uses machine learning to analyze and interpret user preferences. These preferences may be gathered through direct inputs, such as search terms or instructions (e.g., ‘Show only scenes featuring Character X’), or inferred through historical data, such as the user's viewing history, genre preferences, or favorite actors.

Once the system has identified the user's preferences, it retrieves video content from a database or a streaming service. The content is typically tagged with metadata, which describes the individual scenes, characters, or elements of the video. The machine learning system uses this metadata to filter the content, editing out parts of the video that are not relevant to the user's preferences.

What distinguishes this invention from existing patents is its ability to allow the user to input real-time commands via text or voice, enabling the system to make on-the-fly adjustments to the video playback. For instance, a user could say “Show only scenes with the character ‘Betty,’” and the system would immediately adjust the video to meet that request, a feature absent in patents like US20220319549A1 and U.S. Pat. No. 11,170,044.

The edited video is then assembled into a new, personalized version, which is delivered to the user's device (e.g., a television, computer, smartphone, or tablet) through a playback system. The user has the ability to control the playback as they would with any standard video, but with the added benefit of viewing only the customized version of the content.

### Components

### 1. User Input Module:

This module allows the user to specify their preferences either through direct input (e.g., voice commands, text input, or search terms) or through preset rules. The ability to give real-time, dynamic commands during content playback is a key differentiator.

### 2. Machine Learning Engine:

The machine learning engine analyzes the user's inputs and preferences and compares them to metadata associated with the video content. It identifies patterns and determines which elements of the content are relevant to the user.

### 3. Content Filtering and Editing Engine:

This engine is responsible for applying the user's preferences to the video content in real-time. Unlike existing systems that automatically pre-edit content based on generalized metadata, this engine responds dynamically to user commands during playback.

### 4. Playback System:

The playback system delivers the edited video to the user's device. It ensures that the video is formatted correctly for the specific device and that the playback is smooth and uninterrupted.

5. Preference Storage and Feedback Loop:

This component stores the user's preferences and interactions with the system. It uses this information to update the machine learning model, ensuring that future interactions are increasingly personalized and accurate.

1. A system for machine-learning assisted personalized real-time video editing and playback, comprising:
A user input module for receiving user preferences or search terms;
A machine learning engine for analyzing the user's preferences and comparing them to metadata associated with video content;
A content filtering and editing engine for editing the video in real time to match the user's preferences;
A playback system for delivering the edited video content to the user's device.

2. The system of claim 1, wherein the user preferences are based on real-time search terms, direct instructions, or historical viewing data.

3. The system of claim 1, wherein the machine compiles a collection of metadata including tags related to characters, storylines, scenes, or other elements of the video content.

4. A method for machine-learning assisted personalized real-time video editing and playback, comprising:
Receiving user preferences via a user input module;
Analyzing video content metadata using a machine learning engine;
Filtering the video content to remove irrelevant segments based on the user's preferences;
Delivering the edited content dynamically in response to real-time user commands.

5. The method of claim 4, wherein the user preferences are determined through text or voice commands.
